(19) United States
(12) Patent Application Publication
(10) Pub. No.: US 2025/0197630 A1
(43) Pub. Date: Jun. 19, 2025

(54) Biodegradable Polymers for Packaging Applications and Methods of Making the Same

(71) Applicant: Flora Coatings Inc., Phoenix, AZ (US)

(72) Inventor: Atul Tiwari, Phoenix, AZ (US)

(21) Appl. No.: 18/758,019

(22) Filed: Jun. 28, 2024

(51) Int. Cl. C08L 67/02; B29C 48/00; B29C 48/08; B29K 29/00; B29K 67/00; B29K 105/00; B29K 105/16; B29K 401/00; B29L 31/00; C08J 3/20; C08J 5/18; C08L 3/02; C08L 29/04; C08L 67/04

(52) U.S. Cl. CPC C08L 67/02; C08J 3/203; C08J 5/18; C08L 3/02; C08L 29/04; C08L 67/04; B29C 48/0017; B29C 48/022; B29C 48/08; B29K 2003/00; B29K 2029/04; B29K 2067/046; B29K 2105/0029; B29K 2105/0032; B29K 2105/0038; B29K 2105/0044; B29K 2105/0088; B29K 2105/16; B29K 2401/00; B29K 2995/0017; B29K 2995/0046; B29K 2995/006; B29K 2995/0065; B29K 2995/0077; B29K 2995/0089; B29L 2031/712; C08J 2303/02; C08J 2329/04; C08J 2367/02; C08J 2367/04; C08J 2403/02; C08J 2429/04; C08J 2467/02; C08J 2467/04; C08L 2201/06; C08L 2203/10; C08L 2203/16

(57) ABSTRACT

The invention relates to biodegradable polymer packaging films composed of a blend of different biodegradable polymers. These films provide a sustainable alternative to conventional plastic films, offering similar mechanical strength and enhanced biodegradability. The invention outlines the composition, manufacturing process, properties, and applications of the biodegradable films, which decompose under natural environmental conditions, reducing environmental pollution and contributing to a more sustainable packaging solution.

### FIELD OF THE INVENTION:

The present invention relates to biodegradable polymers used in packaging materials. More specifically, it pertains to the development and application of biodegradable polymers as a sustainable alternative to petroleum-based plastics in various packaging applications.

### BACKGROUND OF THE INVENTION:

The increasing environmental concerns associated with petroleum-based plastics, such as pollution and non-biodegradability, have driven the need for more sustainable packaging solutions. Petroleum-based plastics contribute significantly to environmental degradation due to their long decomposition times and harmful effects on wildlife and ecosystems.

Biodegradable polymers offer a promising solution by decomposing naturally through the action of microorganisms, thereby reducing environmental impact. This invention aims to provide a biodegradable polymer composition that exhibits the necessary physical properties for packaging applications while ensuring efficient biodegradability.

### SUMMARY OF THE INVENTION:

The invention provides a biodegradable polymer composition that can be used as a direct replacement for petroleum-based plastics in packaging applications. The composition includes a blend of biodegradable polymers, additives, and fillers designed to achieve optimal mechanical strength, flexibility, and biodegradability.

### DETAILED DESCRIPTION OF THE INVENTION:

Composition

The biodegradable polymer composition comprises:
1. Polylactic Acid (PLA): A biopolymer derived from renewable resources such as corn starch or sugarcane. PLA provides good mechanical properties and is highly biodegradable.
2. Polyhydroxyalkanoates (PHA): Biodegradable polyesters produced by bacterial fermentation. PHA enhances the flexibility and toughness of the polymer blend.
3. Polyvinyl alcohol (PVOH): A biodegradable polymer made from synthetic sources. PVOH enhances degradation pattern.
4. Polybutylene adipate terephthalate (PBAT): A biodegradable polymer made from synthetic sources. PBAT acts as a resin to enhance the strength and stability of the composition.
5. Polybutylene Succinate (PBS): Derived from succinic acid, which can be produced from renewable resources. Good thermal and mechanical properties, biodegradable, and compostable.
6. Starch, derived from plants, is used to improve biodegradability, and reduce costs.
7. Plasticizers: Additives such as glycerol or sorbitol are used to increase the flexibility and processability of the polymer blend.
8. Fillers: Natural fillers like cellulose fibers or calcium carbonate are included to improve mechanical properties and reduce material costs.

### Manufacturing Process

1. Polymer Blending: The biodegradable polymers (PLA, PHA, and starch-based polymers) are blended in specific proportions to achieve the desired mechanical and biodegradability properties.
2. Additive Integration: Plasticizers and fillers are incorporated into the polymer blend using high shear mixing to ensure uniform distribution.
3. Extrusion: The blended polymer composition is extruded into films or sheets using conventional extrusion techniques.
4. Forming: The extruded films or sheets are then thermos-formed, or injection molded into various packaging products, such as containers, bottles, and wraps.

### Properties and Performance

Mechanical Properties: The resulting biodegradable polymer composition exhibits mechanical properties comparable to petroleum-based plastics, including tensile strength, elongation at break, and impact resistance.
Biodegradability: The composition demonstrates efficient biodegradability under composting conditions, breaking down into non-toxic byproducts within a specified time frame.
Barrier Properties: The polymer blend provides sufficient barrier properties to protect packaged goods from moisture, oxygen, and other environmental factors.

### Applications

The biodegradable polymer composition can be used in a wide range of packaging applications, including but not limited to:
Food packaging (trays, containers, wraps)
Beverage packaging (bottles, caps)
Personal care product packaging
Agricultural films and bags
Industrial packaging materials

### Advantages

Environmental Impact: The use of biodegradable polymers significantly reduces the environmental footprint compared to petroleum-based plastics.
Renewable Resources: The primary materials used in the composition are derived from renewable resources, promoting sustainability.
Economic Viability: The incorporation of cost-effective fillers and additives makes the production of biodegradable packaging materials economically viable.

### Conclusion

This invention provides a comprehensive solution to the environmental challenges posed by petroleum-based plastics in packaging applications. By developing a biodegradable polymer composition with desirable physical properties and efficient biodegradability, this invention offers a sustainable alternative that meets the needs of modern packaging while promoting environmental conservation.

What is claimed:

1. A biodegradable polymer composition for packaging applications, comprising blends of:
a. Polybutylene adipate terephthalate (PBAT) in the range of 20-70%,
b. Polylactic Acid (PLA) in the range of 10-40% by weight,
c. Polyhydroxyalkanoates (PHA) in the range of 10-20% by weight,
d. Polybutylene Succinate (PBS) in the range of 5-60% by weight,
e. Polyvinyl alcohol (PVOH) in the range of 5-25% by weight,
f. Starch-based polymers in the range of 5-30% by weight,
g. Plasticizers in the range of 1-15% by weight, and
h. Fillers in the range of 1-20% by weight.

2. The biodegradable polymer composition according to claim 1, wherein the plasticizers are selected from the group consisting of:
a. Glycerol,
b. Sorbitol,
c. Triethyl citrate, and
d. Polyethylene glycol (PEG).

3. The biodegradable polymer composition according to claim 1, wherein the fillers are selected from the group consisting of:
a. Cellulose fibers,
b. Calcium carbonate,
c. Talc, and
d. Lignin.

4. The biodegradable polymer composition according to claim 1, further comprising:
a. Antioxidants in the range of 0.1-2% by weight,
b. UV stabilizers in the range of 0.1-2% by weight, and
c. Colorants in the range of 0.1-5% by weight.
d. Fragrance additives like borneol, camphor, menthol or similar in the range of 1-5% by weight

5. A method of manufacturing biodegradable packaging materials, comprising the steps of:
a. Blending one or all the biodegradable polymers including PLA, PHA, PBAT, PVOH, PBS and starch-based polymers,
b. Incorporating plasticizers and fillers into the polymer blend using high-shear mixing to ensure uniform distribution,
c. Adding optional additives such as antioxidants, UV stabilizers, and colorants,
d. Extruding the blended polymer composition into films or sheets using conventional extrusion techniques, and
e. Forming the extruded films or sheets into packaging products using thermoforming or injection molding techniques.

6. The method according to claim 5, wherein the extrusion is conducted at a temperature range of 150-200° C.

7. The method according to claim 5, wherein the forming process includes:
a. Thermoforming at a temperature range of 80-120° C., and/or
b. Injection molding at a temperature range of 150-200° C.

8. A biodegradable packaging product manufactured from the polymer composition according to claim 1, wherein the packaging product exhibits:
a. Tensile strength in the range of 20-50 MPa,
b. Elongation at break in the range of 5-30%,
c. Impact resistance in the range of 5-20 KJ/m^{2,} and
d. Biodegradability with a decomposition rate of at least 90% within 6 months under industrial composting conditions.

9. The biodegradable packaging product according to claim 8, wherein the product is selected from the group consisting of:
a. Food containers,
b. Beverage bottles,
c. Wrapping films,
d. Bags, and
e. Agricultural mulch films.

10. A biodegradable polymer composition for packaging applications, comprising:
a. Polylactic Acid (PLA) derived from renewable resources such as corn starch or sugarcane,
b. Polyhydroxyalkanoates (PHA) produced by bacterial fermentation,
c. Polybutylene Succinate (PBS) produced from natural source,
d. Polybutylene adipate terephthalate (PBAT)
d. Starch-based polymers from plant sources,
e. Glycerol or silicone as a plasticizer, and
f. Fiber and fragrance compound as a filler,
wherein the composition is designed to achieve a balance of mechanical strength, flexibility, and biodegradability.

11. The biodegradable polymer composition according to claim 1, wherein the composition is further characterized by:
a. Water vapor transmission rate (WVTR) in the range of 10-50 g/m^{2/}day,
b. Oxygen transmission rate (OTR) in the range of 100-500 cc/m^{2/}day, and
c. Thermal stability up to 150° C.

12. A method of enhancing the biodegradability of the polymer composition according to claim 1, comprising the steps of:
a. Pre-treating the starch-based polymers to increase their amorphous content,
b. Incorporating pro-degradant additives such as metal stearates or organic pro-degradants in the range of 0.1-5% by weight, and
c. Optimizing the blend ratio of biodegradable polymers to control the degradation rate.

13. The biodegradable packaging product according to claim 8, further comprising a barrier coating to enhance moisture and oxygen barrier properties, wherein the barrier coating is selected from the group consisting of:
a. Polyglycolic acid (PGA),
b. Silicon oxide (SiOx), and
c. Polyvinyl alcohol (PVOH).

14. The biodegradable packaging product according to claim 1 further comprising a fragrance or scent developing moiety
